(19) United States
(12) Patent Application Publication
(10) Pub. No.: US 2012/0195190 A1
(43) Pub. Date: Aug. 2, 2012

(54) METHOD AND SYSTEM FOR SOLVING COMMUNICATION FAILURE AND TRAFFIC LOSS IN SERVICE PROTECTION NETWORKS

(75) Inventors: Rajnath Singh, Richardson, TX (US); Guoliang Wu, Plano, TX (US); David Traylor, Allen, TX (US); Si Long Ho, Allen, TX (US)

(73) Assignee: FUJITSU NETWORK COMMUNICATIONS, INC., Richardson, TX (US)

(21) Appl. No.: 13/360,300

(22) Filed: Jan. 27, 2012

Related U.S. Application Data
(60) Provisional application No. 61/438,125, filed on Jan. 31, 2011.

(51) Int. Cl. H04L 12/24

(52) U.S. Cl. 370/225

(57) ABSTRACT

A method for solving communication failure includes transmitting user traffic over an automatic protection switching (“APS”) connection between a near network node and a far network node, determining that a protect path on the APS connection has failed, sending a message to the far network node that the protect path has failed, and switching user traffic to the working path at the near network node.

### RELATED APPLICATION

This application claims the benefit under 35 U.S.C. §119(e) of U.S. Provisional Application Ser. No. 61/438,125 filed Jan. 31, 2011, entitled “METHOD AND SYSTEM FOR SOLVING COMMUNICATION FAILURE AND TRAFFIC LOSS IN SERVICE PROTECTION NETWORKS.”

### TECHNICAL FIELD OF THE INVENTION

The present invention relates generally to networked communications and, more particularly, to a method and system for solving communication failure and traffic loss in service protection networks.

### BACKGROUND

Ethernet automatic protection switching under the G.8031 standard may use protected paths, one active and one backup, to communicate between virtual local area networks. The paths are monitored, and if one of the paths is detected as faulty, the backup path may take over and traffic continues to flow. The G.8031 standard has heretofore dictated the specific protocol for switching traffic between the paths in a variety of circumstances.

### SUMMARY

In one embodiment, a method for solving communication failure includes transmitting user traffic over an automatic protection switching (“APS”) connection between a near network node and a far network node, determining that a protect path on the APS connection has failed, sending a message to the far network node that the protect path has failed, and switching user traffic to the working path at the near network node.

In another embodiment, an article of manufacture includes a computer readable medium and computer-executable instructions carried on the computer readable medium. The instructions are readable by a processor. The instructions, when read and executed, cause the processor to transmit user traffic over an APS connection between a near network node and a far network node, determine that a protect path on the APS connection has failed, send a message to the far network node that the protect path has failed, and switch user traffic to the working path at the near network node.

In yet another embodiment, a switch system includes a near switch and an automatic protection switching (“APS”) connection communicatively coupled to the near switch. The switch includes a computer readable medium, a processor coupled to the computer readable medium, and computer-executable instructions carried on the computer readable medium. The instructions are readable by the processor. The instructions, when read and executed, cause the processor to transmit user traffic over the APS connection between the near switch and a far switch, determine that a protect path on the APS connection has failed, send a message to the far network node that the protect path has failed, and switch user traffic to the working path at the near network node.

### BRIEF DESCRIPTION OF THE DRAWINGS

For a more complete understanding of the present invention and its features and advantages, reference is now made to the following description, taken in conjunction with the accompanying drawings, in which:

FIG. 1 is an example embodiment of a system for solving communication failure and traffic loss in service protection networks;

FIG. 2 is an example illustration of the operation of the system during normal operation;

FIG. 3 is an illustration of the operation of the system during conditions that may cause a loss of user traffic;

FIG. 4 is an illustration of the operation of the system after switches have detected a loss in automatic protection switching (“APS”) message traffic over a protect path;

FIG. 5 is an illustration of the operation of the system after a switch has sent an APS message to another switch indicating a failure a protect path in the switch; and

FIG. 6 is an example embodiment of a method for solving communication failure and traffic loss in service protection networks by monitoring for APS communication interruptions.

### DETAILED DESCRIPTION

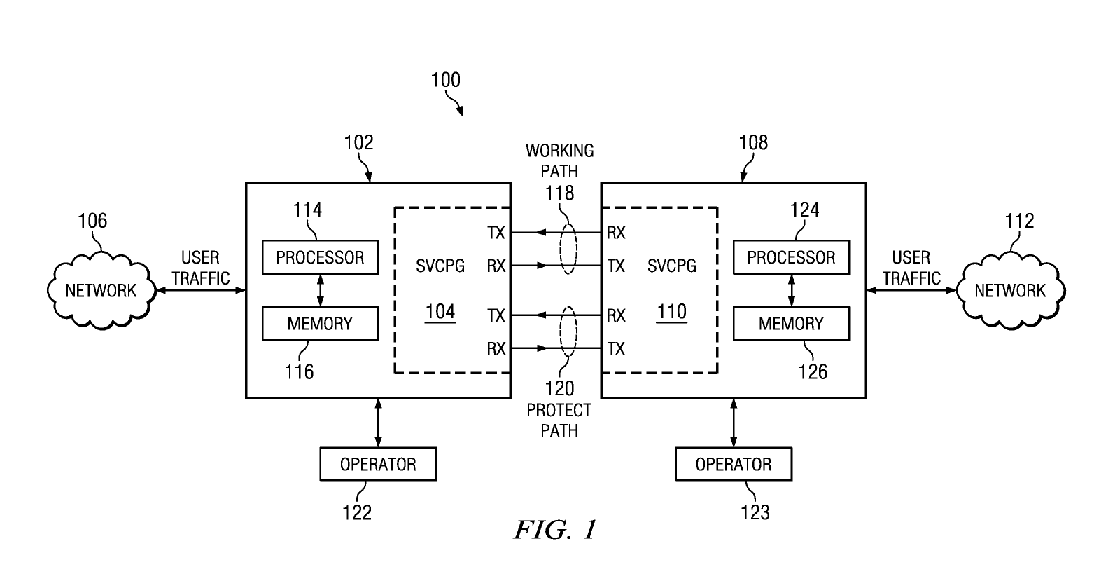

FIG. 1 is an example embodiment of a system 100 for solving communication failure and traffic loss in service protection networks. In one embodiment, system 100 may be configured to solve communication failure and traffic loss associated with automatic protection switching (“APS”) message failure. In another embodiment, system 100 may be configured to solve communication failure and traffic loss in G.8031 service protection networks. Such a network may include a one-to-one (1:1) protected configuration. System 100 may include some or all of a one-to-one bidirectional G.8031 network. System 100 may include a network entity such as switch 102 communicatively coupled to another network entity such as switch 108. Switch 102 and switch 108 may be communicatively coupled to exchange information, and to transport user traffic between network destinations such as those found in network 106 or network 112.

Switch 102 and switch 108 may be communicatively coupled through a network, sub-network, local-area-network, wide-area-network, an intranet, then Internet, various network entities, or any suitable combination thereof. Switch 102 may include one or more virtual groups of transmission tunnels. Such a group may include an Ethernet service protection group (“SVCPG”) 104. Switch 108 may include one or more virtual groups of transmission tunnels. Such a group may include an SVCPG 110. SVCPGs 104, 110 may be communicatively coupled to each other. SVCPGs 104, 110 may be implemented as logical entities within switches 102, 108 respectively. SVCPGs 104, 110 may include paths 118, 120, as well as any other suitable resource. System 100 may be configured to prevent traffic loss caused by concurrent bidirectional wait-to-restore mechanisms in either SVCPG 104, 110, occurring during networked communication between the two.

Network 106 may comprise any suitable network—for example, a local-area-network, wide-area-network, a network of metro Ethernet switches, virtual-local-area-network, an intranet, or a portion of the Internet. Network 112 may comprise any suitable network—for example, a local-area-network, wide-area-network, a network of metro Ethernet switches, virtual-local-area-network, an intranet, or a portion of the Internet.

Switch 102 may be communicatively coupled to switch 108 through SVCPG 104. Switch 108 may be communicatively coupled to switch 102 through SVCPG 110.

System 100 may include an operator 122 communicatively coupled to one or more portions of the network of system 100, such as switch 102. System 100 may include additional operators, such as operator 123 communicatively coupled to other portions of the network of system 100, such as switch 108. In one embodiment, operator 122 and/or operator 123 may include an electronic device configured to receive information about the operation of system 100. Operator 122 and/or operator 123 may include an electronic device configured to make changes in system 100 in response to information about the operation of system 100. For example, operator 122 and/or operator 123 may be configured to set the state of operation of switch 102 or switch 108. Operator 122 and/or operator 123 may be configured to make some of such changes automatically. In another embodiment, operator 122 and/or operator 123 may include interfaces for human administrators of the system 100 to receive information regarding the operation of system 100, and to enter desired changes in system 100 in response to the information.

Switch 102 may include a processor 114 coupled to a memory. Processor 114 may comprise, for example, a microprocessor, microcontroller, digital signal processor (DSP), application specific integrated circuit (ASIC), or any other digital or analog circuitry configured to interpret and/or execute program instructions and/or process data. Switch 102 may interpret and/or execute program instructions and/or process data stored in memory 116. Memory 116 may comprise any system, device, or apparatus configured to hold and/or house one or more memory modules. Each memory module may include any system, device or apparatus configured to retain program instructions and/or data for a period of time (e.g., computer-readable media).

In one embodiment, switch 108 may include a processor 124 coupled to a memory 126. Processor 124 may comprise, for example, a microprocessor, microcontroller, digital signal processor (DSP), application specific integrated circuit (ASIC), or any other digital or analog circuitry configured to interpret and/or execute program instructions and/or process data. Switch 108 may interpret and/or execute program instructions and/or process data stored in memory 126. Memory 126 may comprise any system, device, or apparatus configured to hold and/or house one or more memory modules. Each memory module may include any system, device or apparatus configured to retain program instructions and/or data for a period of time (e.g., computer-readable media).

Switch 102 may be configured to solve APS communication failure and traffic loss in G.8031 service protection networks according to some or all of the teachings of this disclosure. In one embodiment, switch 108 may be implemented in the same way as switch 102 with regards to solving APS communication failure and traffic loss in G.8031 service protection networks. In such an embodiment, switch 108 and switch 102 may be implemented in the same or related makes or models of switches. In another embodiment, switch 108 may not be implemented in the same way as switch 102 with regards to solving APS communication failure and traffic loss in G.8031 service protection networks. In such an embodiment, switch 108 may be implemented with only features conforming to the G.8031 standard. Switch 108 may thus be of a different makes or models of switches. In such a case, switch 108 may be provided by a third party.

Switch 102 and switch 108 may communicate using linear protected switching. Switch 102 and switch 108 may be communicatively coupled through a linearly protected switching connection. The linearly protected switching connection may include a protected path. In one embodiment, the protected path may form a portion of a G.8031 protected path. In a further embodiment, the protected path may comprise a working path 118 and a protect path 120. Each of working path 118 and protect path 120 may include routes through a number of network entities between switch 102 and switch 108. Each of working path 118 and protect path 120 may include two transmission media. Such transmission media may include any suitable media such as fiber or copper. In one embodiment, two of such transmission media may interface with each of SVCPG 104 and SVCPG 110 to form a transmission tunnel and a reception tunnel. Switch 102 and switch 108 may be communicatively coupled through SVCPG 104 and SVCPG 110 over working path 118 and protect path 120. One of paths 118, 120 may be designated as active, wherein a switch using paths 118, 120 for user traffic will transmit and receive packets making up the user traffic over the active path, but ignore such user traffic on the other path. User traffic may include customer traffic originating and travelling to destinations in network 106 and network 112. User traffic may flow on working path 118 or protect path 120, depending upon the configuration of switches 102 and 108. Such a configuration may determine which of the paths is active and thus carrying user traffic. In one embodiment, user traffic may be transmitted on either the working path 118 or on the protection path 120, but not on both paths simultaneously. Thus if the two switches 102, 108 transmit user traffic on different paths, user traffic may be lost. The switches 102, 108 may monitor the protection path 120 for control and status messages, such as APS messages. APS messages may implement a control packet. APS messages may include protocol messages. APS messages may include property and state information of an originating SVCPG. In one embodiment, the working path 118 may be initially configured as the active path. If working path 118 is down or otherwise unavailable, then protect path 120 may be configured as the active path for user traffic. In another embodiment, switch 102 and switch 108 may exchange user traffic over the active path, but only exchange APS messages over protect path 120. In such an embodiment, if protect path 120 is unavailable then APS messages may be lost. APS messages and user traffic may thus be able to be transmitted at times on the same protect path 120. System 100 may thus be configured to transport user traffic between various networked entities in system 100, such as between those in network 106 and in network 112.

Switch 102 may be configured to receive a packet of information of user traffic from a network entity in network 106, and forward the information across working path 118 and/or protect path 120 to switch 108 for delivery to a network entity in network 112. Switch 102 may be configured to exchange control information, statuses, or other messages regarding the communication itself with switch 108. Switch 102 may be configured to exchange such information over protect path 120. Such information may be in the form of APS messages.

Switch 108 may be configured to receive a packet of information of user traffic from switch 102 for delivery to a destination address in network 112. Switch 108 may be configured to receive control information, statuses, or other messages regarding the communication itself from switch 108 and take appropriate action based on such information. Switch 102 may be configured to exchange such information over protect path 120. Such information may be in the form of APS messages.

Switches 102, 108 may be configured to operate in pre-determined states of operation, depending upon the conditions encountered. Pre-determined states of operation may indicate any suitable information about operational settings or conditions encountered. For example, pre-determined states of operation may indicate to switches 102, 108 which path 118, 120 should be used for communication of user traffic given the occurrence of a particular event.

Switch 102 may be configured to notify operator 122 regarding any change in the status of communication between switch 102 and switch 108. For example, if encountering communication difficulties on a particular path 118, 120 switch 102 may take corrective action to resume communication with switch 108 to minimize the loss of information. In such a case, switch 102 may notify operator 122 of actions taken, conditions observed, and may implement subsequent actions required by operator 122. Switch 102 may be configured to make state changes based on information or instructions received from operator 122.

Switch 108 may be configured to notify operator 123 regarding any change in the status of communication between switch 102 and switch 108. For example, if encountering communication difficulties on a particular path 118, 120 switch 108 may take corrective action to resume communication with switch 108 to minimize the loss of information. In such a case, switch 108 may notify operator 123 of actions taken, conditions observed, and may implement subsequent actions required by operator 123. Switch 108 may be configured to make state changes based on information or instructions received from operator 123.

Switch 102 and switch 108 may be configured to periodically exchange APS messages. Such messages may be exchanged in both directions. Switch 102 and switch 108 may be configured to exchange APS messages on protect path 120.

Conditions may arise that may cause one or both of switch 102 and switch 108 to lose communication of the APS messages. Such conditions may include, for example, congestion in the network on protect path 120, the deletion of one of the SVCPGs 104, 110, or disabling G.8031 protection in one of the SVCPGs 104, 110. Such conditions may affect the transmission of APS messages in one direction. For example, switch 108 may be able to receive APS messages sent by switch 102, but switch 102 may not be able to receive APS messages sent by switch 108. The loss of APS messages, without additional action, may adversely affect one or more services being carried on the network connection as described below.

In addition to such a loss of APS messages, a decision may be made at one of the switches to switch traffic from working path 118 to protect path 120. For example, for maintenance reasons operator 123 may instruct switch 108 to switch user traffic to protect path 120 using a MAN/FORCE command. Switch 108 may not be aware of the problems that switch 102 is encountering in receiving APS messages from switch 108. Thus, without any such notifications from switch 102, switch 108 may transition user traffic to be transported over protect path 120. Switch 108 may send an APS message to switch 102 with information about the change in user traffic. However, since switch 102 may be having difficulty receiving APS messages from switch 108, switch 102 may not be informed of the impending change in paths, and may instead continue to transmit and monitor for user traffic on working path 118. As a consequence, a complete traffic loss in the user traffic may result. Such a situation may arise under these or similar circumstances if switches 102, 108 implement the G.8031 standard. However, one or both of switches 102, 108 may be configured as described below to handle these and other situations.

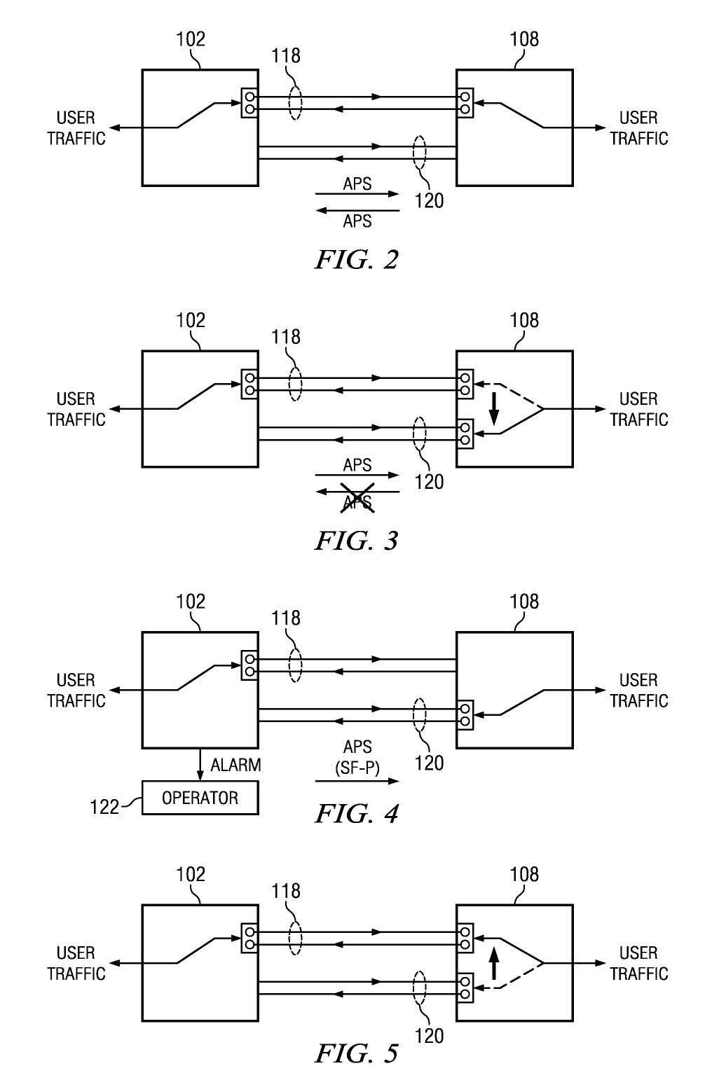

FIG. 2 is an example illustration of the operation of system 100 during normal operation. Switch 102 may be configured to exchange user traffic with switch 108 over working path 118, which may be acknowledged by both switches as active. Protect path 120 may be reserved as a backup path. Switch 102 and switch 108 may exchange APS messages in each direction over protect path 120.

FIG. 3 is an illustration of the operation of system 100 during conditions that may cause a loss of user traffic. Conditions may arise such that the receiving tunnel of switch 102 at the protect path becomes congested or otherwise unusable. Switch 102 may not receive APS messages from switch 108. In addition, conditions may arise that cause switch 108 to switch transmission of user traffic from working path 118 to protect path 120.

Switch 102 may be configured to monitor protect path 120 for APS message traffic. Switch 102 may be configured to use a countdown timer to determine for how long APS messages have not been received. Any suitable countdown period may be used by switch 102 to monitor protect path 120 for APS messages. The period may vary between different SVCPGs, according to priority, physical distance, quantity of network entities between the SVCPGs, speed of connections, kinds of traffic to be handled, the expected flow of data, or any other suitable criteria. The period may be set by operator 122. In one embodiment, a countdown period of three times the APS communication period may be used. In another embodiment, the APS communication period may be five seconds. Upon receipt of an APS message, switch 102 may be configured to reset the countdown timer for the SVCPG through which the APS message was received. The countdown timer may be implemented in memory 116, or in any other suitable mechanism. If the countdown expires, switch 102 may be configured to determine that the APS traffic has been interrupted.

FIG. 4 is an illustration of the operation of system 100 after switches 102 has detected a loss in APS message traffic over protect path 120. Even though switch 108 may still be receiving APS message traffic over protect path 120 and thus the protect path 120 may at least be partially in working order, switch 102 may be configured to send a message to switch 108 indicating that the protect path has failed. Such a message may normally indicate to switch 108 that the protect path has failed, and switch 108 may take standard operating procedures in accordance with such a status. In one embodiment, switch 108 may be configured to switch user traffic to working path 118 upon receipt of a message that protect path 120 has failed.

To send a message to switch 108 claiming that the protect path 120 has failed, switch 102 may generate an “SF-P” event and place it within an APS message to be sent to switch 108. Switch 102 may be configured to move traffic to working path 118, send the APS message on the protection path 120 to switch 108, and send an alarm to operator 122.

FIG. 5 is an illustration of the operation of system 100 after switch 102 has sent an APS message to switch 108 with an “SF-P” event, or otherwise indicated a failure in protect path to switch 102. Switch 108 may be configured to receive a signal failure message such as one containing “SF-P” from switch 102. Switch 108 may be configured to evaluate the instruction in the APS message against any current states of execution of switch 108, to determine whether the received message may overrule the presently executing state. Such a determination may be made by consulting a hierarchy of command or state priorities. For example, switch 108 may be configured to accept the actions implied by the “SF-P” signal over a previously received instruction from an operator to manually switch user traffic from working path 118 to protect path 120. Switch 108 may be configured to move its traffic to the working path 118 in accordance with the received instruction. In one embodiment, switch 108 may be in a lockout state when receiving the message from switch 102, and may ignore the message. In another embodiment, switch 108 may be configured to ignore the message when switch 108 is already transmitting user traffic on the working path 118.

Consequently, even if switch 108 is implemented using only the G.8031 standard, switch 102 may be configured to solve one-to-one bidirectional APS communication failure and traffic loss in G.8031 service protection networks. In addition, switch 102 may be configured to solve one-to-one bidirectional APS communication failure and traffic loss in G.8031 service protection networks without any information as to the status of switch 108. Switch 108 may be transmitting user traffic on either path 118, 120.

In operation, switch 102 may be receiving user traffic on working path 118 from another entity such as switch 108 through SVCPG 110. Switch 102 may reset a countdown timer each time an APS message is received via a given SVCPG, such as SVCPG 104. Switch 102 may receive settings for the countdown timer from operator 122. If the countdown timer expires, switch 102 may determine that an interruption in APS traffic has occurred on protect path 120.

Switch 102 may send a failure indication such as “SF-P” in an APS message to switch 108 on the protect path 120. Switch 102 may move user traffic to working path 118, if such user traffic is not already being transmitted on working path 118. Switch 102 may send an alarm to operator 122.

Upon receipt of a message such as “SF-P” from switch 102, switch 108 may move to the corresponding state of operation. For example, if “SF-P” was received as part of the APS message, switch 108 may move user traffic to the working path 118. Switch 108 may evaluate the message against any existing statuses before implementing or ignoring the message.

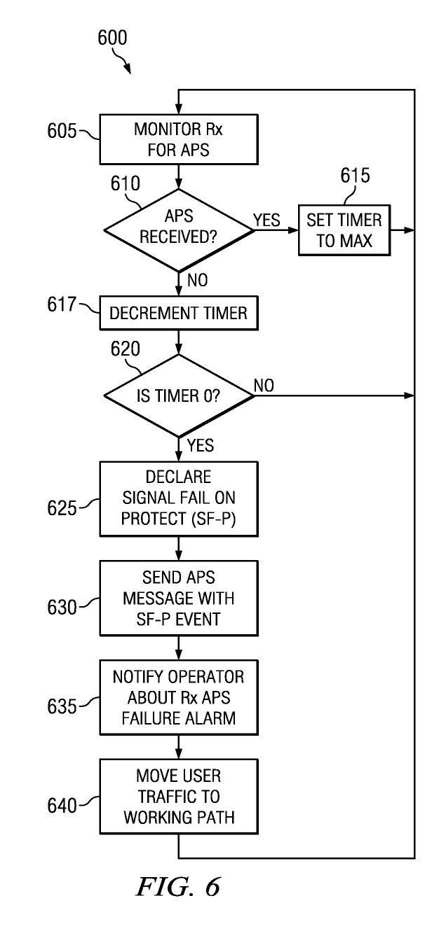

FIG. 6 is an example embodiment of a method 600 for solving communication failure and traffic loss in service protection networks by monitoring for APS communication interruptions. In step 605, a path may be monitored for control messages. In one embodiment, the path may be one portion of a G.8031 protected path. In another embodiment, the path may be the receiving tunnel of a protect path. In yet another embodiment, the path may be monitored for APS messages from another network entity.

In step 610, it may be determined whether any of the monitored-for traffic has been encountered on the observed path. In one embodiment, it may be determined whether any APS messages have been received on the receiving tunnel of the protect path. If such traffic has been received, in step 615 a timer may be reset to a maximum value, and the method 600 may resume monitoring at step 605.

If no such traffic has been received, then in step 617 the timer may be decremented. In step 620 it may be determined whether the timer has reached zero. If the timer has not reached zero, then the countdown may be updated and the method 600 may resume monitoring the active path at step 605.

If the timer has reached zero, then in step 625 it may be determined that APS messages on the receiving tunnel of the protect path has been interrupted. A signal failure on the protect path may be declared. Such a signal failure may be designated by “SF-P.” In step 630, an APS message with an SF-P even may be sent over the protect path. Such a message may indicate to other entities to switch to a different state of operation, which may include communicating over a different path. Such a message may be sent to a network entity with which user traffic has been exchanged. In step 635, an alarm may be sent to an operator indicating the path and the type of failure that has been encountered.

In step 640, user traffic may be moved to working path, if necessary. After step 640, the method 600 may resume monitoring in step 605.

Although FIG. 6 discloses a particular number of steps to be taken with respect to an example method 600, method 600 may be executed with more or fewer steps than those depicted in FIG. 6. In addition, although FIG. 6 discloses a certain order of steps to be taken with respect to method 600, the steps comprising method 600 may be completed in any suitable order.

Method 600 may be implemented using the system of FIGS. 1-5 or any other system, network, or device operable to implement method 600. In certain embodiments, method 600 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims. For example, in some embodiments the operations of switch 102 may also be conducted by switch 108, and vice-versa.

What is claimed is:

1. A method for solving communication failure, comprising:
transmitting user traffic over an automatic protection switching (“APS”) connection between a near network node and a far network node;
determining that a protect path on the APS connection has failed;
sending a message to the far network node that the protect path has failed; and
switching user traffic to the working path at the near network node.

2. The method of claim 1, further comprising, at the far network node:
compare the received message against previously received instructions;
determine to follow the received message over the previously received instructions; and
switch user traffic to the working path at the far network node.

3. The method of claim 1, wherein determining that the protect path on the APS connection has failed further comprises:
monitoring the protect path for APS message traffic;
resetting a countdown timer upon receipt of an APS message on the protect path;
decrementing the countdown timer upon no receipt of an APS message on the protect path; and
determining that the protect path on the APS connection has failed in response to the countdown timer expiring.

4. The method of claim 3, wherein the time period of the countdown timer is five seconds.

5. The method of claim 3, wherein the time period of the countdown timer is a determined multiple of the APS communication period.

6. The method of claim 1, wherein the message includes an SF-P event within an APS message.

7. The method of claim 1, wherein sending a message to the far network node that the protect path has failed is performed without knowledge of the state of the far network node.

8. An article of manufacture comprising:
a computer readable medium; and
computer-executable instructions carried on the computer readable medium, the instructions readable by a processor, the instructions, when read and executed, for causing the processor to:
transmit user traffic over an automatic protection switching (“APS”) connection between a near network node and a far network node;
determine that a protect path on the APS connection has failed;
send a message to the far network node that the protect path has failed; and
switch user traffic to the working path at the near network node.

9. The article of claim 8, wherein the processor is further caused to, at the far network node:
compare the received message against previously received instructions;
determine to follow the received message over the previously received instructions; and
switch user traffic to the working path at the far network node;

10. The article of claim 8, wherein causing the processor to determine that the protect path on the APS connection has failed further comprises causing the processor to:
monitor the protect path for APS message traffic;
reset a countdown timer upon receipt of an APS message on the protect path;
decrement the countdown timer upon no receipt of an APS message on the protect path; and
determine that the protect path on the APS connection has failed in response to the countdown timer expiring.

11. The article of claim 8, wherein the message includes an SF-P event within an APS message.

12. The article of claim 8, wherein sending a message to the far network node that the protect path has failed is performed without knowledge of the state of the far network node.

13. A switch system comprising:
a near switch comprising a computer readable medium and a processor coupled to the computer readable medium;
an automatic protection switching (“APS”) connection communicatively coupled to the near switch; and
computer-executable instructions carried on the computer readable medium, the instructions readable by the processor, the instructions, when read and executed, for causing the processor to:
transmit user traffic over the APS connection between the near switch and a far switch;
determine that a protect path on the APS connection has failed;
send a message to the far network node that the protect path has failed; and
switch user traffic to the working path at the near network node.

14. The system of claim 13, further comprising the far switch, the far switch configured to:
compare the received message against previously received instructions, and determining to follow the received message over the previously received instructions; and
switch user traffic to the working path at the far network node;

15. The system of claim 13, wherein causing the processor to determine that the protect path on the APS connection has failed further comprises causing the processor to:
monitor the protect path for APS message traffic;
reset a countdown timer upon receipt of an APS message on the protect path;
decrement the countdown timer upon no receipt of an APS message on the protect path; and
determine that the protect path on the APS connection has failed in response to the countdown timer expiring.

16. The system of claim 15, wherein the time period of the countdown timer is five seconds.

17. The system of claim 15, wherein the time period of the countdown timer is a determined multiple of the APS communication period.

18. The system of claim 13, wherein the message includes an SF-P event within an APS message.

19. The system of claim 13, wherein configuring the processor to send a message to the far network node that the protect path has failed is performed without knowledge of the state of the far network node.
